(19) United States
(12) Patent Application Publication
(10) Pub. No.: US 2004/0130227 A1
(43) Pub. Date: Jul. 8, 2004

(54) Centrifugal force cyclic energy generator

(76) Inventor: Charles F. Ricker, Spring Creek, NV (US)

Correspondence Address: Charles F. Ricker, P.O. Box 1691, Elko, NV, 89803, US

(21) Appl. No.: 10/336,451

(22) Filed: Jan. 2, 2003

(51) Int. Cl. H02P 15/00

(52) U.S. Cl. 310/103

(57) ABSTRACT

A perpetual motion machine of the first kind utilizing centrifugal force as the energy generator and accumulator. Whenever an object is rotated, centripetal and centrifugal forces are generated perpendicular to the axis of rotation. By capturing those forces with rotating Weights (116) and storing them in Springs (126) along the axis of rotation, the angular momentum and kinetic energies of the rotating object are conserved. All these forces and energies, less minor friction, can be safely and conveniently extracted and regenerated, producing net energy gains exceeding thousands of percent.

### BACKGROUND OF THE INVENTION

This invention relates to energy generation, specifically utilizing centrifugal force as an energy accumulator.

From the 1982 5^{th} edition of the McGraw-Hill Encyclopedia of Science and Technology, Volume 2, page 755: “Centrifugal force A fictitious or pseudo outward force on a particle about an axis which by Newton's third law is equal and opposite to the centripetal force. Like all such action-reaction pairs of forces, they are equal and opposite but do not act on the same body and so do not cancel each other.”

From the 1982 5^{th} edition of the McGraw-Hill Encyclopedia of Science and Technology, Volume 10, page 41:“Perpetual motion The expression perpetual motion, or perpetuum mobile, arose historically in connection with the quest for a mechanism which, once set in motion, would continue to do useful work without an external source of energy or which would produce more energy than it absorbed in a cycle of operation. This type of motion, now called perpetual motion of the first kind, involves only one of the three distinct concepts presently associated with the idea of perpetual motion. First kind. Perpetual motion of this type refers to a mechanism whose efficiency exceeds 100%. Clearly such a mechanism violates the now firmly established principle of conservation of energy, in particular that statement of the principle of conservation of energy embodied in the first law of thermodynamics. (Indeed, the first law of thermodynamics is sometimes stated as “A perpetuum mobile of the first kind cannot exist.”) Thus, with the establishment of the energy conservation principle in the middle of the 19^{th} century, the possibility of obtaining perpetual motion of the first kind could be denied. However, prior to that time, some ingenious machines, generally dependent upon gravity for their “operation”, had been devised.”

The force of gravity is pretty much the same at any location on the surface of the earth, a virtual constant. On the other hand, centrifugal force is infinitely variable and can be generated as a periodic or cyclic action.

The principle of the conservation of energy was established and disseminated to the scientific community by Hermann Helmholtz in a series of lectures delivered in Germany in 1862-1863. Although Helmholtz and others since him have considered numerous instances of force, work, energy, and motion in heat, mechanics, magnetism, electricity, and chemicals, they apparently have not explored the ramifications of centrifugal force. Specifically that centripetal and centrifugal are equal and opposite but do not operate on the same body and thus do not cancel each other. And that doubling the speed of rotation returns FOUR times the force.

Almost any physics textbook in use since the nineteenth century tries to convey the impossibility of the creation of energy. The principle of conservation of energy has never been conclusively proven, just assumed because not unproven, until now.

Newton's laws happen to be in agreement with nature to a certain extent. They are not all inclusive, however, as demonstrated by Einstein

Newton's First Law of Motion: A particle not subjected to external forces remains at rest or moves with constant speed in a straight line. For Angular Motion: A body not acted upon by a torque continues in its state of rest or if spinning continues to spin with constant angular momentum.

Flywheels are sometimes used to store kinetic energy for later use. For instance, torque is applied by an electric motor and kinetic energy is stored in the flywheel. Disregarding friction, the flywheel would, in theory, spin forever. The same electric motor used to spin the flywheel can also be used as a generator to later extract the kinetic energy from the flywheel with an efficiency exceeding 95%.

Newton's Second Law of Motion: The acceleration of a particle is directly proportional to the resultant external force acting on the particle and is inversely proportional to the mass of the particle. For Angular Motion: The rate of change of angular momentum equals the applied torque.

However, centripetal acceleration is measured at a right angle, or perpendicular to angular momentum and any applied or extracted torque.

Newton's Third Law of Motion: If two particles interact, the force exerted by the first particle on the second particle (called the action force) is equal in magnitude and opposite in direction to the force exerted by the second particle on the first particle (called the reaction force). For Angular Motion: Corresponding to a torque applied to one body (action) there is always an equal, opposite torque on another (reaction). These three laws describe and allow for the measurement of kinetic energy and angular momentum, but centrifugal force is not equal and opposite to kinetic energy, centrifugal force is a by-product generated at right angles to rotational kinetic energy and angular momentum. Flywheel design engineers know that if certain rotational speeds are exceeded, the flywheel will literally explode due to the tremendous centrifugal forces generated. A car going too fast around a corner can literally be forced off the road and caused to roll over several times due to centrifugal force. Centripetal and centrifugal forces have been perceived as something hazardous to be avoided or dealt with for the most part, but sometimes used for good as in a centrifuge to separate materials, or by NASA to create artificial G-forces.

The tremendous energy created by the dangerous by-product of a spinning flywheel, centrifugal force, can be safely extracted for other useful purposes without affecting the kinetic energy stored in the flywheel, or violating the Law of the Conservation of Angular Momentum, contrary to popular belief.

### BRIEF SUMMARY OF THE INVENTION

Doubling the rotational speed of a spinning object requires only twice as much torque, however it produces four times as much energy. With this generator, that energy can be safely extracted without reducing the angular momentum stored in the spinning object. Therefore, the kinetic energy put into the spinning object can also be reclaimed, resulting in a very small net energy input to obtain a very large energy output.

Several objects and advantages of the present invention are to:

(a) provide excess usable electricity utilizing a non-polluting renewable source of energy;

(b) reduce pollution on planet Earth;

(c) reduce global warming;

(d) reduce coal mining and destruction of the land;

(e) reduce American dependence on foreign oil;

(f) reduce the need for dangerous nuclear power plants; and

(g) decrease the cost of energy for the consumer.

Still further objects and advantages will become apparent from a consideration of the ensuing description and drawings.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

FIG. 1 is a perspective view of the core of the generator in an uncharged position.

FIG. 2 is a perspective view of the core of the generator in a charged position.

FIG. 3 is a perspective view of the core of the generator in the uncharged position, and an energy extraction assembly in the uncharged position.

FIG. 4 is a perspective view of the core of the generator in the charged position, and an energy extraction assembly in the uncharged position.

FIG. 5 is a perspective view of the core of the generator in the charged position, and an energy extraction assembly in the charged position.

FIG. 6 is a perspective view of the core of the generator after discharging the stored spring energy, and an energy extraction assembly in the discharged position.

FIG. 7 includes a possible framework.

FIG. 8 demonstrates a close-up view of the lock release mechanism.

FIGS. 9, 10, and 11 are semi-exploded perspective views of the core of the generator.

FIG. 12 shows a perspective view of the generator in the uncharged position.

### LIST OF REFERENCE NUMERALS

101 Front Main Bearing 125 Inner Main Spring

102 Rear Main Bearing 126 Outer Main Spring

103 Main Drive Shaft 130 Sliding Plate

104 Main Drive Shaft Lock Collar 131 Lock Base

105 Main Drive Shaft Gear 132 Lock Bracket

106 Main Drive Motor Gear 133 Lock Shaft

107 Main Drive Gear Belt 134 Lock Spring

108 Electric Main Drive Motor 135 Lock

109 Pulley Support Bolts 140 Lower Lock Arm Shaft

110 Base Plate 141 Lower Lock Arm

111 Pulley Support 142 Middle Lock Arm Shaft

112 Pulley Bearing 143 Upper Lock Arm

113 Pulley Bearing Shaft 144 Upper Lock Arm Shaft

114 Pulley 145 Lock Arm Alignment Plate

115 Guide Arm 146 Lock Arm Alignment Plate Bolt

116 Weight 147 Lock Arm Alignment Plate Washer

117 Wire Cable with Swaged Ends 150 Push Rod

118 Wire Cable Lock Washer 151 Push Rod End

119 Wire Cable Nut 152 Push Rod Trigger

120 Corner Post 160 Hydraulic Cylinder

121 Post Top 163 Hydraulic Pump

122 Corner Post Lock Washer 164 Hydraulic Motor

123 Corner Post Nut 172 Electric Generator

### DETAILED DESCRIPTION OF THE INVENTION

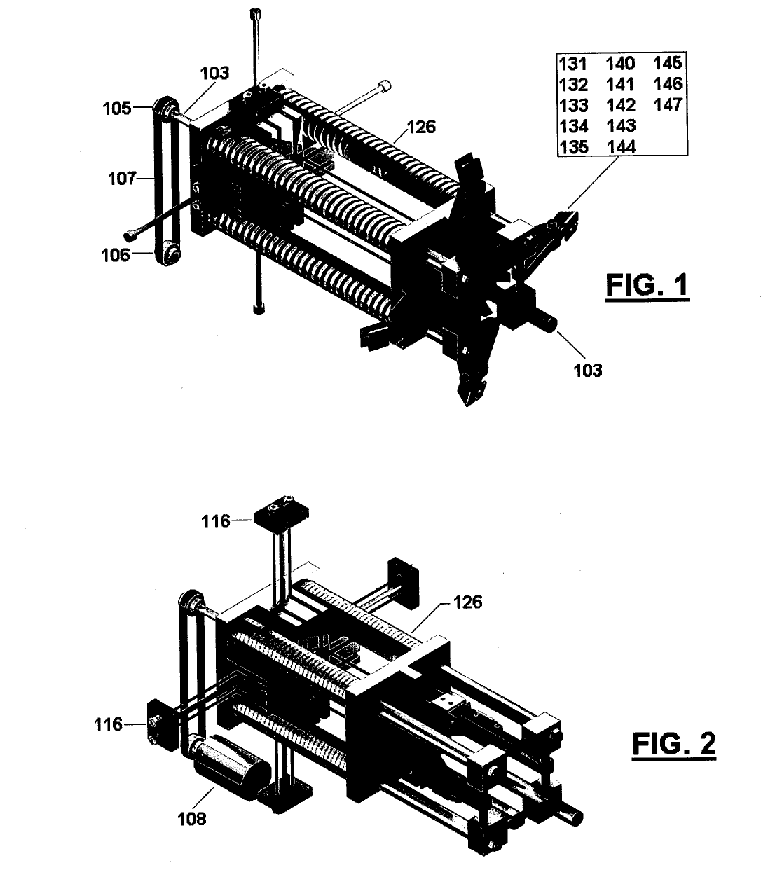

FIG. 1 is a perspective view of the core of the generator showing Main Springs 126 in the uncharged, uncompressed position. A Main Drive Gear Belt 107 attaches between a Main Drive Motor Gear 106 and a Main Drive Shaft Gear 105. Main Drive Shaft Gear 105 is secured to Main Drive Shaft 103. Of course, a motor connected directly in line with a drive shaft would work as well in most instances. The locking mechanism assemblies 131 through 147 are in the uncharged, unlocked position.

FIG. 2 is a perspective view of the core of the generator showing Main Springs 126 in the charged, compressed position. Four Weights 116 are shown in the charged, extended position. An Electric Main Drive Motor 108 is shown attached to Main Drive Motor Gear 106. Electric Main Drive Motor 108 connects to conventional batteries, battery charging system, and timing control devices (not shown). The locking mechanism assemblies 131 through 147 are in the charged, locked position.

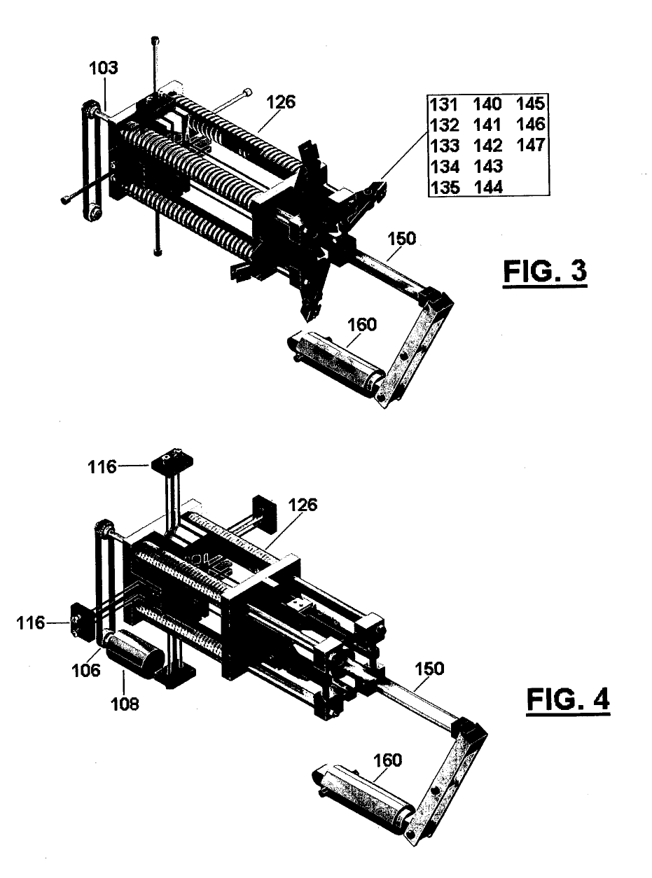

FIG. 3 is a perspective view of the core of the generator showing Main Springs 126 in the uncharged, uncompressed position. The locking mechanism assemblies 131 through 147 are in the uncharged, unlocked position. A Push Rod 150, with freedom of rotational and linear movement around and along Main Drive Shaft 103, and a Hydraulic Cylinder 160 are shown in their respective uncharged conditions. Mounting a hydraulic cylinder, or other energy extraction device, directly in line with the drive shaft is preferable in most cases.

FIG. 4 is a perspective view of the core of the generator showing Main Springs 126 in the charged, compressed position. Four Weights 116 are shown in the charged, extended position. Electric Main Drive Motor 108 is shown attached to Main Drive Motor Gear 106. The locking mechanism assemblies 131 through 147 are in the charged, locked position. Push Rod 150 and Hydraulic Cylinder 160 are displayed in their respective uncharged positions.

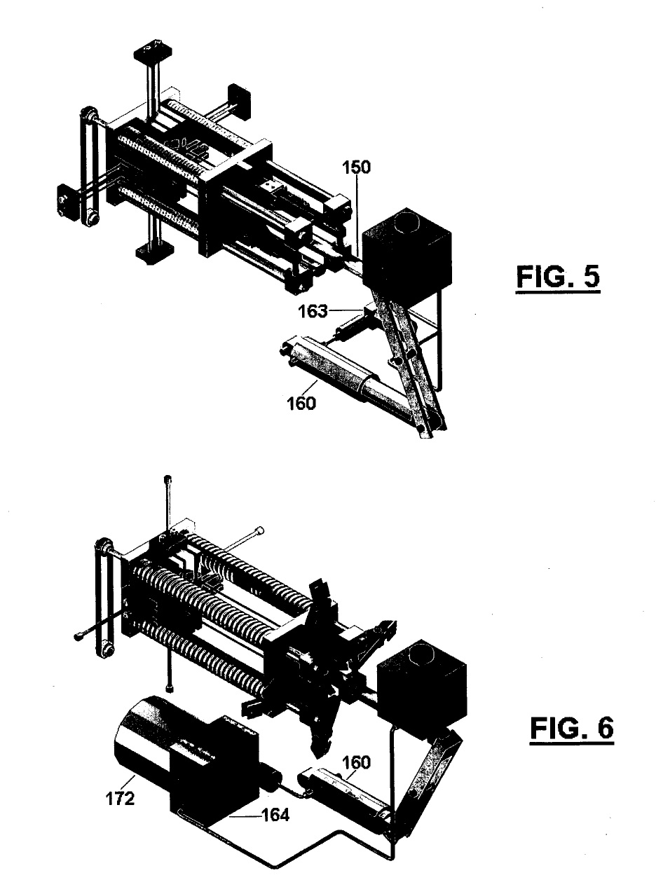

FIG. 5 is a perspective view of the rotating parts of this generator in the charged, compressed, extended, and locked condition. A Hydraulic Pump 163 can be used to fill Hydraulic Cylinder 160 with oil, placing Hydraulic Cylinder 160 and Push Rod 150 in their respective charged positions.

FIG. 6 is a perspective view of the rotating parts of this generator in the discharged, uncompressed, retracted, and unlocked condition. An Electrical Generator 172 and a Hydraulic Motor 164 are shown attached to Hydraulic Cylinder 160 via hydraulic hose and fittings. Output from Electrical Generator 172 is connected to conventional batteries and battery charging system (not shown).

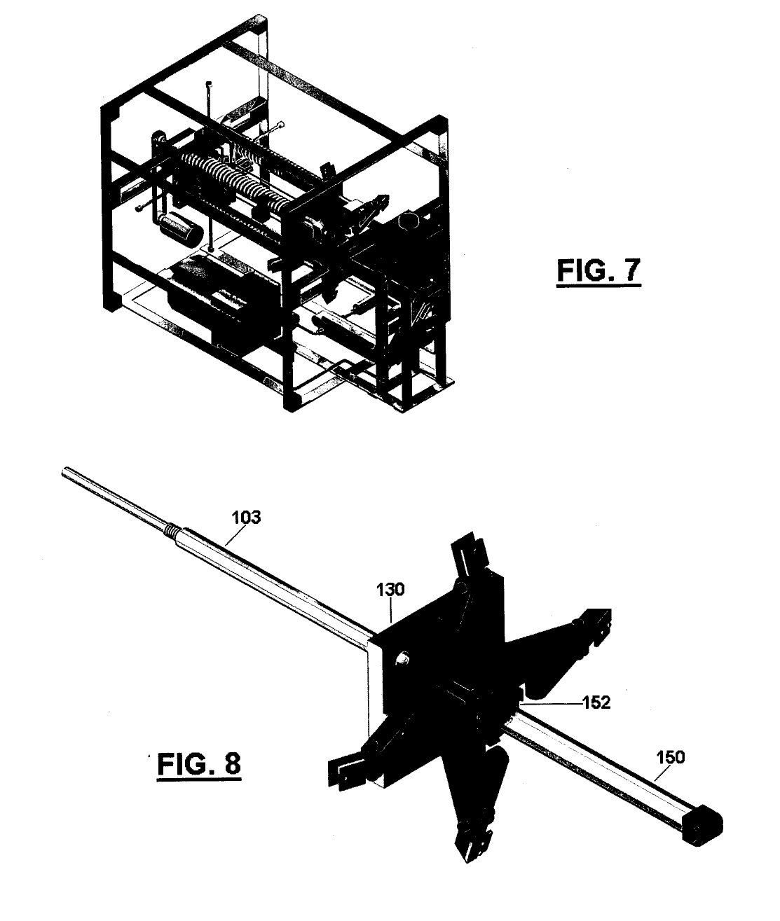

FIG. 7 includes a possible framework. The frame could be composed of welded or bolted steel or aluminum, or any other combination of materials and fastenings capable of containing the tremendous energies generated by centrifugal force.

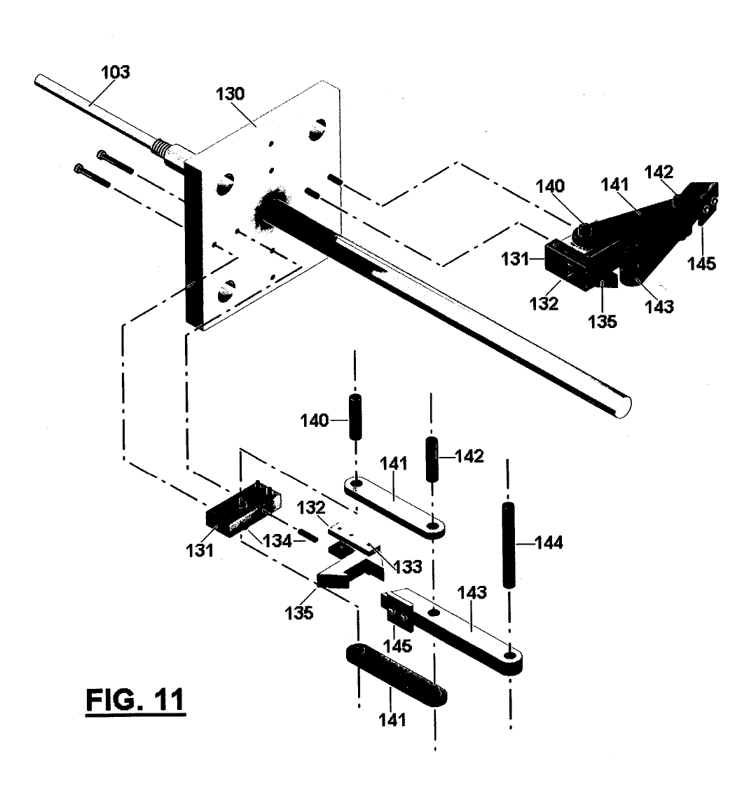

FIG. 8 demonstrates a close-up view of the lock release mechanism. A steel Push Rod 150 slides freely on the Main Drive Shaft 103. A Push Rod Trigger 152 is welded, or otherwise attached to Push Rod 150 at just the right point to allow for the release of Locks 135 (FIG. 11) as Push Rod 150 touches Sliding Plate 130.

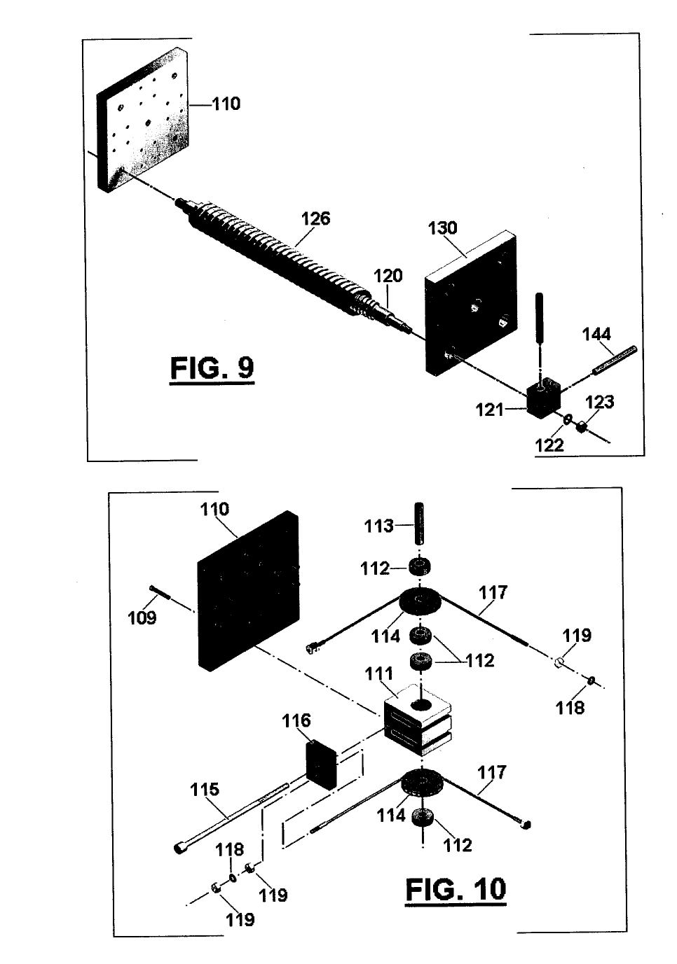

FIG. 9 is a semi-exploded perspective view of Base Plate 110, Sliding Plate 130, Corner Post 120, Post Top 121, Main Spring 126, and related parts. In the preferred embodiment (designed to power an average 3 bedroom home), Sliding Plate 130 is an aluminum block 30.48 cm×30.48 cm×3.81 cm (12″×12″×1.5″) drilled in five places with 3.81 cm (1.5″) diameter holes allowing Sliding Plate 130 to slide freely on Main Drive Shaft 103 (as shown in FIG. 8) and Corner Posts 120. The four Corner Posts 120 are aluminum rods 3.81 cm (1.5″) diameter by 86.36 cm (34″) long, threaded on one end for a 2.54 cm (1″) diameter tapped hole, and threaded on the other end for a 2.54 cm (1″) diameter Corner Post Nut 123. In this particular application, five Main Springs 126 are composed of nested springs: five left-handed inner springs 60.96 cm (24″) long with an inside diameter of 3.96 cm (1.56″), an outside diameter of 5.555 cm (2.187″), and a wire diameter of 0.79 cm (0.312″); and five right-handed outer springs 60.96 cm (24″) long with an inside diameter of 5.64 cm (2.22″), an outside diameter of 8.016 cm (3.156″), and a wire diameter of 1.189 cm (0.468″). Each of the inner springs has a spring rate of 28.13 kg per cm (157.4 pounds per inch). Each of the outer springs has a spring rate of 46.48 kg per cm (260.1 pounds per inch). Main Springs 126 will experience a compression distance of 22.86 cm (9″) and a total load of 8527.65 kg (18787.5 pounds) during each cycle of operation. There are four 1.905 cm (0.75″) diameter by 15.24 cm (6″) long steel Upper Lock Arm Shafts 144, that slide into the four Post Tops 121.

FIG. 10 is a semi-exploded perspective view of a Base Plate 110 and related parts. In the preferred embodiment, Base Plate 110 is a 30.48 cm×30.48 cm×3.81 cm (12″ by 12″ by 1.5″) block of die-cast aluminum drilled and tapped in five places for a 2.54 cm (1″) diameter thread. A Main Drive Shaft 103 (shown in FIG. 8) made of steel is screwed into the 2.54 cm (1″) diameter tapped center hole of Base Plate 110. Main Drive Shaft 103 is 127 cm (50″) long, including a 25.4 cm (10″) length by 1.905 cm (0.75″) diameter machined part protruding below Base Plate 110. There are four aluminum Pulley Supports 111, 10.16 cm×10.16 cm×12.7 cm (4″ by 4″ by 5″), secured to Base Plate 110 with 0.9525 cm (0.375″) diameter steel Pulley Support Bolts 109. There are sixteen Pulley Bearings 112, four bearings for each Pulley Support 111. Each Pulley Bearing 112 having a minimum static load rating of 794.325 kg (1750 pounds). There are eight steel Pulleys 114, 10.16 cm (4″) outside diameter by 1.27 cm (0.5″) thick, attached to Pulley Supports 111 with four steel Pulley Bearing Shafts 113. There are four Guide Arms 115, one for each Pulley Support 111. Each Guide Arm 115 is a 1.27 cm (0.5″) diameter by 38.1 cm (15″) long aluminum rod. Each Guide Arm 115 screws into a Pulley Support 111. There are four steel Weights 116, one for each Guide Arm 115. Each Weight 116 weighs 1.82 kg (4 pounds), slides freely on the Guide Arm 115, and is drilled for Wire Cable 117 attachment. There are a total of eight Wire Cables 117, each 0.635 cm (0.25″) diameter multi-stranded (7×1 g) aircraft quality cable with swaged and threaded ends rated at 2950.35 kg (6500 pounds) minimum breaking load.

FIG. 11 is a semi-exploded perspective view of Sliding Plate 130 and the locking mechanisms. There are four Lock Bases 131 attached to Sliding Plate 130 with 0.635 cm (0.25″) diameter steel bolts. Eight Lock Springs 134 slide into the four Lock Bases 131. Eight Lock Brackets 132 attach to the sides of the four Lock Bases 131 with small steel bolts. Four Locks 135 slide between Lock Brackets 132 and sit on Lock Springs 134. A small retaining Lock Shaft 133 secures each Lock 135 to each Lock Bracket 132 yet allows Lock 135 to swivel. A Lower Lock Arm Shaft 140 slides through each Lock Base 131. Two Lower Lock Arms 141, with 1.905 cm (0.75″) diameter holes on 16.51 cm (6.5″) centers, attach to each Lower Lock Arm Shaft 140 and are allowed freedom to swivel. Four Middle Lock Arm Shafts 142 are used to attach four Upper Lock Arms 143, with 1.905 cm (0.75″) diameter holes on 16.51 cm (6.5″) centers, to eight Lower Lock Arms 141. All lower and middle lock arm shafts are 1.905 cm (0.75″) steel rods grooved on each end for retaining rings (not shown) to secure the lock arms yet allow for freedom to swivel. A Lock Arm Alignment Plate 145 is attached to each Upper Lock Arm 143 using Lock Arm Alignment Plate Bolts 146 and Lock Washers 147. A 1.905 cm (0.75″) diameter steel Upper Lock Arm Shaft 144 (FIG. 8) slides through each Upper Lock Arm 143. For best results, each Upper Lock Arm Shaft 144 should be exactly in line with its corresponding Lower Lock Arm Shaft 140, and when in the charged position, with Middle Lock Arm Shaft 142.

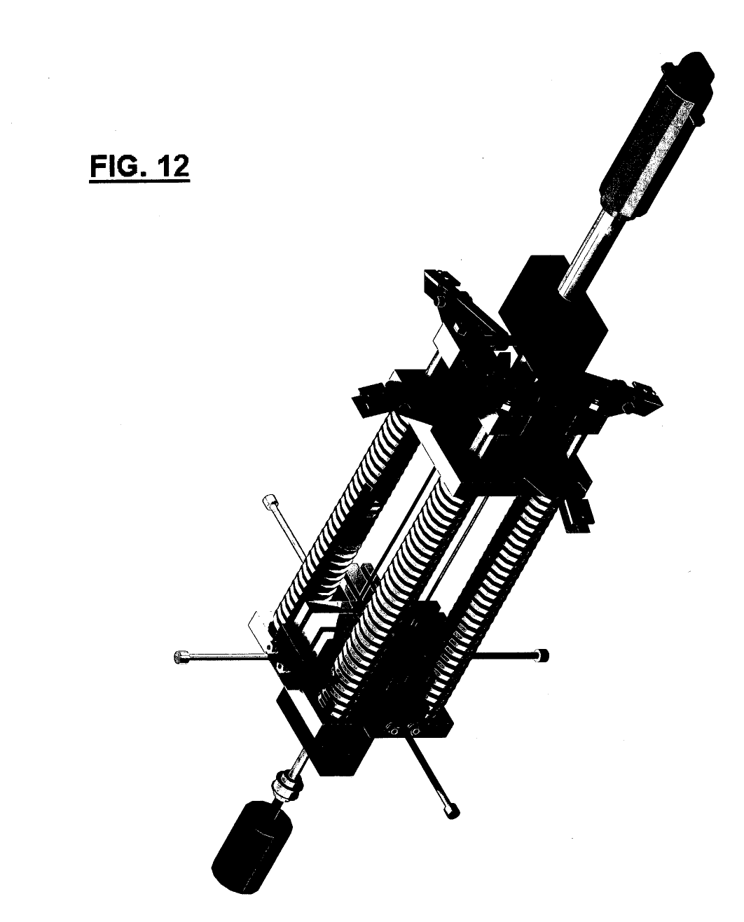

FIG. 12 shows a perspective view of the generator in the uncharged position. The drive motor and hydraulic cylinder are attached in-line with the drive shaft.

This particular embodiment of the generator creates excess usable energy from centrifugal force in the following fashion:

1) When the core of the machine is momentarily rotated by a 1 HP, 1700 RPM Electric Main Drive Motor 108 for about 1 second, centrifugal force equal to more than 8,170 kg (18,000 pounds) pulls four, 1.82 kg (4 pound) Weights 116 away from the center of rotation (FIG. 4). Wire Cables 117 attached between Weights 116 and Sliding Plate 130 via Pulleys 114 compress Main Springs 126 approximately 22.86 cm (9″), storing over 8,170 kg (18,000 pounds) of force. The locking mechanisms hold Main Springs 126 in the compressed position.

2) Most of the kinetic energy now stored in the spinning machine is extracted by using Electric Main Drive Motor 108 as a generator, for a net energy input of only about 0.2 horsepower.

3) After the machine comes to a complete stop, one option of spring energy to electricity conversion is to use a very small Hydraulic Pump 163 to fill a 7.62 cm (3″) diameter Hydraulic Cylinder 160 with oil (FIG. 5), forcing Push Rod Trigger 152 to trip the locking mechanisms, transferring the energy stored in Main Springs 126 into hydraulic pressure that is used to rotate a Hydraulic Motor 164 connected to a 5 HP Electrical Generator 172 (FIG. 6). The energy released from Main Springs 126 in this particular embodiment within 2.5 seconds is equal to approximately 9,511.2 joules (84,544 inch pounds), or 3,804.525 joules (33,818 inch pounds) per second, or about 5.1 horsepower for 2.5 seconds, for a net energy output exceeding 6,000%.

4) After all the energy stored in Main Springs 126 has been converted into electricity, the cycle of actions is automatically repeated utilizing conventional mechanical or computerized timing controls (not shown).

Conclusions, Ramifications, and Scope

The possibility of the creation of energy should never have been in question. By simply placing two magnets in closer proximity, the energy required to keep them apart is magnified in inverse proportion to the square of the distance. NASA uses planetary gravitational forces to slingshot space vehicles such as the Voyagers from planet to planet and beyond. Centripetal acceleration is directly proportional to the square of the velocity, so doubling the velocity returns four times the acceleration. Force equals mass multiplied by acceleration. The problem has not been the creation of energy, but the safe extraction of the energy created. This generator solves that problem.

Although the description above contains many specificities, these should not be construed as limiting the scope of the generator but as merely providing illustrations of some of the presently preferred embodiments of this invention. For example, workable units of almost any size and horsepower can be safely designed, produced, and operated, as long as conventional engineering practices are followed and the craftsman understands centripetal and centrifugal force as defined in any accurate physics textbook. Quantity and compressive strength of springs is infinitely variable. Quantity and strength of locking mechanism assemblies per machine is variable. For that matter, with slight design modifications, springs can be compression or extension, and the locking mechanisms can be relocated and modified to obtain the same locking result. Type of material used to make each part is not as critical as strength of material. Rotational speeds are infinite. With the addition of appropriate conventional battery banks, invertors, battery chargers, and mechanical or computerized timing controls, machines can be produced that stand alone, act as emergency back-up systems for home or industrial use, or supply power directly into the national energy grid.

Thus the scope of the generator should be determined by the appended claims and their legal equivalents, rather than by the examples given.

1. I claim a perpetual motion machine of the first kind, comprising:
a. rotary means for creating centrifugal force energy,
b. extraction means for capturing said energy, and
c. converting means for changing said energy into usable forms,
whereby said energy may be used to perform work.
